(19) United States
(12) Patent Application Publication
(10) Pub. No.: US 2009/0250951 A1
(43) Pub. Date: Oct. 8, 2009

(54) STRIKE PLATE, KIT AND METHOD OF SECURING A DOOR AGAINST FORCED ENTRY

(76) Inventor: PABLO RODRIGUEZ, Norco, CA (US)

Correspondence Address: James Ray & Associates, 2640 Pitcairn Road, Monroeville, PA, 15146, US

(21) Appl. No.: 12/394,511

(22) Filed: Feb. 27, 2009

Related U.S. Application Data
(60) Provisional application No. 61/067,228, filed on Apr. 3, 2008.

(51) Int. Cl. E05B 15/02; E04G 21/00

(52) U.S. Cl. 292/340; 52/745.15

(57) ABSTRACT

A strike plate is provided. Such strike plate includes a substantially flat member, manufactured from a predetermined material and having a predetermined size and a predetermined shape. Such substantially flat member includes a first aperture disposed there through for receiving a bolt portion of a deadbolt attached to a door. A securing mechanism is engageable with such substantially flat member and a door frame of such door for securing such substantially flat member to such door frame.

### CROSS REFERENCE TO RELATED APPLICATION

This patent application is related to and claims priority from U.S. Provisional Patent Application Ser. No. 61/067,228 filed Apr. 3, 2008.

### FIELD OF THE INVENTION

The present invention relates, in general, to strike plates, more particularly, this invention relates to a strike plate for use with a deadbolt lock to prevent forced entry into a home or other building.

### BACKGROUND OF THE INVENTION

Prior to the conception and development of the present invention, strike plates, as are generally well known in the prior art, may be affixed to a door frame and include a hole for receiving the bolt of a door. When the door is closed, the bolt extends into the hole in the strike plate, and holds the door closed. The strike plate protects the door frame against friction from the bolt, and increases security in the case of a door frame made of a softer material (such as wood) than the strike plate.

Specifically of interest to the present invention are the following: Allen, U.S. Pat. No. 4,547,009, discloses a strike plate for mounting on a door jamb to receive the dead bolt of a door mounted lock wherein the strike plate is provided with a buck pin that is offset from the bolt receiving aperture of the plate so as to be insertable in an opening provided in the strongest part of the wall supporting structure.

Detlefs, U.S. Pat. No. 4,186,954, discloses a lock strike plate assembly which includes a lock bolt housing for insertion into a recess of a door jamb and a brace member extending from the back of the housing internally into the adjoining wall support.

Thorp, U.S. Pat. No. 4,415,191, discloses a reinforcing structure for a door and lock mechanism of a type having a bolt. The door abuts an elongated door stop carried on a door jamb in the closed position. A strike plate has a bolt receiving aperture therein and is configured to have at least portions extending into recesses in the associated elongated door stop. Screws extend through the portions for mounting the strike plate on the associated door jamb. A jamb plate is dimensioned and configured for mounting on the door stop with a first edge thereof in generally parallel relationship to a side of the strike plate and extending substantially to an edge of the door stop which abuts the associated door when in the closed position.

### SUMMARY OF THE INVENTION

The present invention provides a strike plate. Such strike plate includes a substantially flat member, manufactured from a predetermined material and having a predetermined size and a predetermined shape. Such substantially flat member includes a first aperture disposed there through for receiving a bolt portion of a deadbolt attached to a door. A securing mechanism is engageable with such substantially flat member and a door frame of such door for securing such substantially flat member to such door frame.

According to another embodiment, a strike plate kit is provided for use with a door hingedly mounted to a door frame, such door including a deadbolt. Such strike plate kit includes a strike plate including a substantially flat member manufactured from a predetermined material and having a predetermined size. Such substantially flat member is L-shaped. Such L-shaped substantially flat member includes a first elongated arm and a second shorter arm. A first aperture is disposed through such first elongated arm for receiving a bolt portion of such deadbolt. A second aperture is disposed through such first elongated arm above such first aperture and is for receiving a first screw member having a first predetermined length. A third aperture is disposed through such first elongated arm below such first aperture and is for receiving a second screw member having a second predetermined length. A fourth aperture is disposed through such second shorter arm at a predetermined location for receiving a third screw member having a third predetermined length. Such strike plate kit further includes such respective first, second, and third screw members for screwing through such second, third, and fourth apertures and into such door frame to secure such substantially flat member to such door frame. Such strike plate kit further includes a plurality of elongated screws having a predetermined size and a predetermined length for replacing a plurality of predetermined screws from such hinges connecting such door to such door frame.

According to still another embodiment, a method of securing a door, hingedly connected to a door frame and including a deadbolt, against forced entry is provided. Such method includes the steps of: providing a strike plate including a substantially flat member, manufactured from a predetermined material and having a predetermined size, such substantially flat member being L-shaped and including a first elongated arm and a second shorter arm, such substantially flat member further including a first aperture disposed through such first elongated arm for receiving a bolt portion of such deadbolt, a second aperture for receiving a first screw member having a first predetermined length, such second aperture disposed through such first elongated arm above such first aperture, a third aperture for receiving a second screw member having a second predetermined length, such third aperture disposed through such first elongated arm below such first aperture, and a fourth aperture for receiving a third screw member having a third predetermined length, such fourth aperture disposed through such second shorter arm at a predetermined location. Such method further includes aligning such strike plate at a predetermined location on such door frame and holding such strike plate in place, drawing an outline around such strike plate, removing such strike plate from such door frame and chiseling a recess into such door frame within such outline such that such strike plate may be fitted into such recess flush with such door frame, providing such first, second, and third screw members and screwing such first, second, and third screw members into such second, third, and fourth apertures of such strike plate respectively and into such door frame thereby securing such strike plate within such recess and to such door frame, removing a plurality of predetermined screws from a plurality of apertures disposed through a plurality of predetermined hinge plates, such hinge plates being secured to such door frame and hingedly securing such door to such door frame, providing a predetermined number of elongated screws having a predetermined length, such predetermined number being equal to the number of such screws removed from such hinge plates, and screwing such elongated screws into such predetermined apertures.

### OBJECTS OF THE INVENTION

It is, therefore, one of the primary objects of the present invention to provide a strike plate which reinforces the ability of a door and its associating door frame to withstand forced entry.

Another object of the present invention is to provide an improved strike plate for attachment to a door frame, such improved strike plate acts as a hinge type mechanism which forced such door in at least one of a downward direction, an upward direction, and a combination thereof upon such door being subject to force such as pressure aimed at facilitating a forced entry by such person exerting such pressure.

Still another object of the present invention is to provide a strike plate which is easy to install and which provides a user with an improved sense of security.

Yet another object of the present invention is to provide a strike plate kit which includes a strike plate, at least one elongated screw for securing such strike plate to a door frame, and at least one additional elongated screw for replacing at least one screw from a hinge plate connected to such door frame and connecting such door to such door frame, such kit for use in preventing robberies, burglaries, home invasions, and the like.

Still another object of the present invention is to provide a method for securing a door against forced entry.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention.

FIG. 3 is a partial perspective view of the invention according to one embodiment of the invention.

FIG. 4 is a partial perspective view of the invention according to one embodiment of the invention.

FIG. 5 is a partial perspective view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

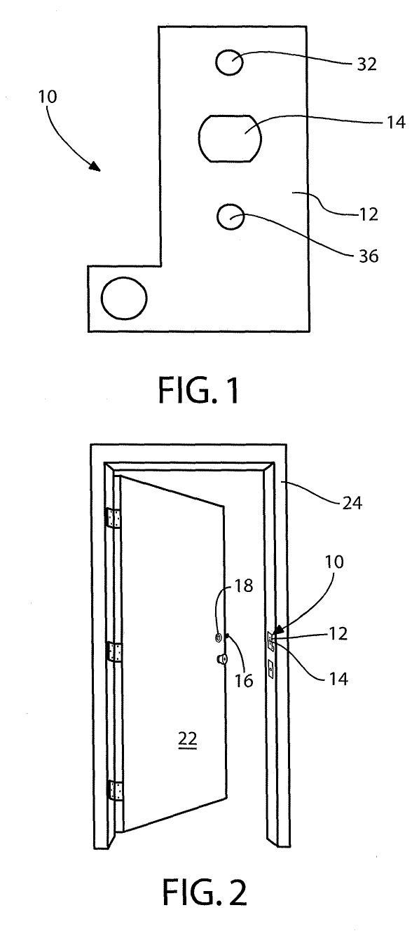

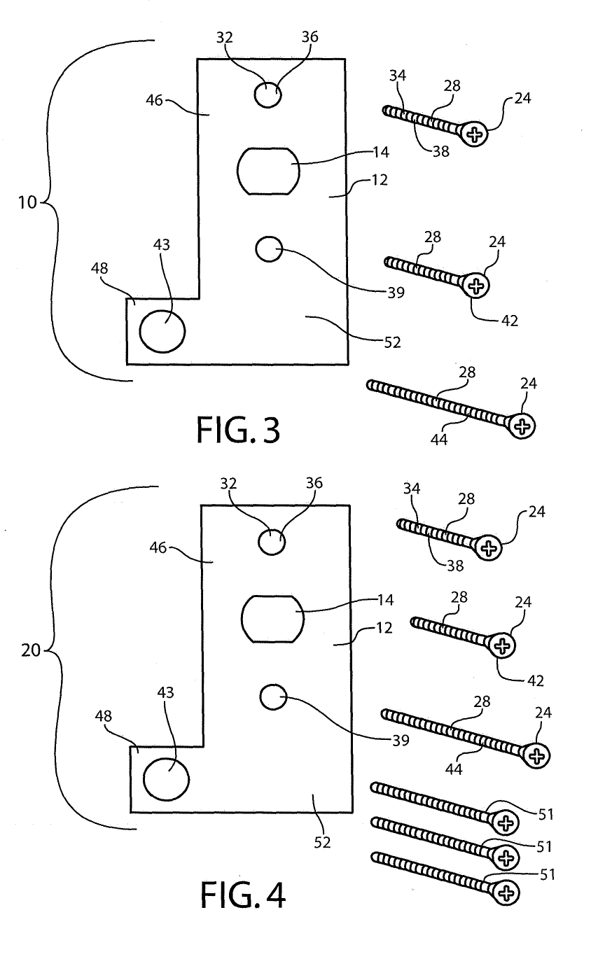

Reference is now made, more particularly, to FIGS. 1-5.

Referring more specifically to FIG. 1-3, a strike plate, generally designated 10, is provided. Such strike plate 10 includes a substantially flat member 12, manufactured from a predetermined material and having a predetermined size and a predetermined shape.

Such substantially flat member 12 includes a first aperture 14 disposed there through for receiving a bolt portion 16 of a deadbolt 18 attached to a door 22.

A securing means 24 is engageable with such substantially flat member 12 and a door frame 24 of such door 22 for securing such substantially flat member 12 to such door frame 24.

It is presently preferred that such first predetermined material is a metal, preferably at least one of aluminum and steel. It is presently most preferred that such metal is steel.

It is presently preferred that such securing means 24 is a screw type securing means 28 and such substantially flat member 12 further includes at least one second aperture 32 disposed there through for receiving at least one screw member 34 there through.

It is further presently most preferred that such strike plate 12 further includes a second aperture 36 for receiving a first screw member 38 having a first predetermined length, such second aperture 36 disposed through such substantially flat member 12 above such first aperture 14, a third aperture 39 for receiving a second screw member 42 having a second predetermined length, such third aperture 39 disposed through such substantially flat member 12 below such first aperture 14, and a fourth aperture 43 for receiving a third screw member 44 having a third predetermined length disposed through such substantially flat member 12 at a predetermined location. It is presently preferred that such first and second predetermined lengths are substantially identical and such third predetermined length is longer than such first and such second predetermined lengths.

According to the presently preferred embodiment, such predetermined shape is substantially L-shaped. It is further presently preferred that such L-shaped substantially flat member 12 includes a first elongated arm 46 for vertical placement on such door frame and a second shorter arm 48 extending from a first predetermined end 52 of such first elongated arm 46 and wherein such first aperture 14 is disposed through a substantially central portion of such first elongated arm 46 and such fourth aperture 43 is disposed through a substantially central portion of such second shorter arm 48.

It is presently preferred that such strike plate 10 is between about 3.0 inches and 4.0 inches in length.

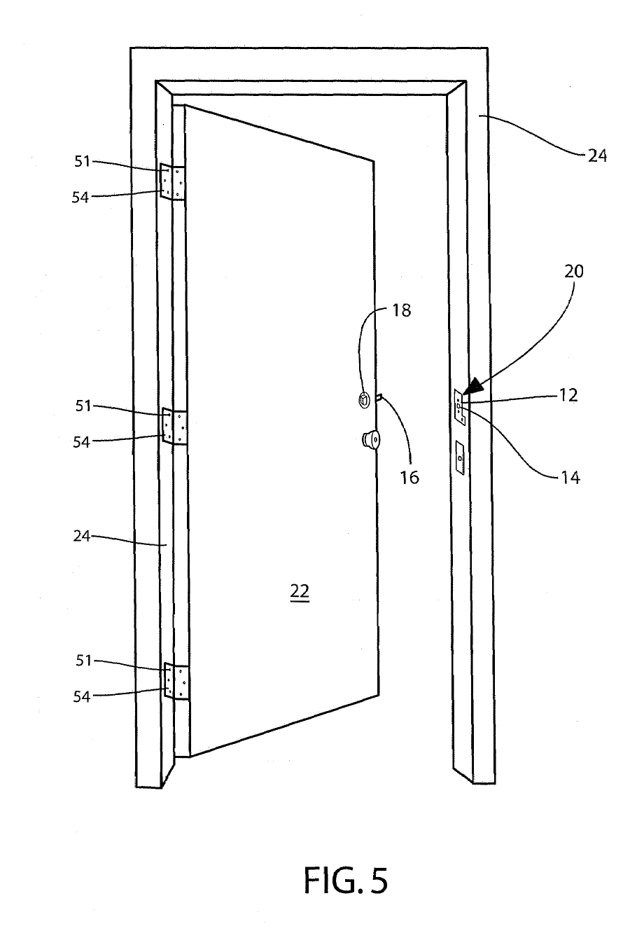

According to another embodiment, referring to FIGS. 4-5, a strike plate kit, generally designated 20, is provided for use with a door 22 hingedly mounted to a door frame 24, such door 22 including a deadbolt 18. Such strike plate kit 20 includes a strike plate, generally designated 10, including a substantially flat member 12 manufactured from a predetermined material and having a predetermined size. Such substantially flat member 12 is L-shaped. Such L-shaped substantially flat member 12 includes a first elongated arm 46 and a second shorter arm 48 extending from a first predetermined end 52 of such first elongated arm 46. A first aperture 14 is disposed through such first elongated arm 46 for receiving a bolt portion 16 of such deadbolt 18. A second aperture 36 is disposed through such first elongated arm 46 above such first aperture 14 and is for receiving a first screw member 38 having a first predetermined length. A third aperture 39 is disposed through such first elongated arm 46 below such first aperture 14 and is for receiving a second screw member 42 having a second predetermined length. A fourth aperture 43 is disposed through such second shorter arm 48 at a predetermined location, such fourth aperture for receiving a third screw member 44 having a third predetermined length. Such strike plate kit 20 further includes such first screw member 38, such second screw member 42, and such third screw member 44 for screwing through such second, third, and fourth apertures respectively and into such door frame 24 to secure such substantially flat member 12 to such door frame 24. It is presently preferred that such third screw member 44 is elongated. Such strike plate kit 20 also includes a plurality of elongated screws 51 having a predetermined size and a predetermined length for replacing a plurality of predetermined screws (not shown) from hinges 54 connecting such door 22 to such door frame 24.

According to still another embodiment, a method of securing a door hingedly connected to a door frame and including a deadbolt type lock against forced entry is provided. Such method includes the steps of: providing a strike plate including a substantially flat member, manufactured from a predetermined material and having a predetermined size, such substantially flat member being L-shaped and including a first elongated arm and a second shorter arm, such substantially flat member further including a first aperture disposed through such first elongated arm for receiving a bolt portion of such deadbolt, a second aperture for receiving a first screw member having a first predetermined length, such second aperture disposed through such first elongated arm above such first aperture, a third aperture for receiving a second screw member having a second predetermined length, such third aperture disposed through such first elongated arm below such first aperture, and a fourth aperture for receiving a third screw member having a third predetermined length disposed through such second shorter arm at a predetermined location. Such method further includes aligning such strike plate at a predetermined location on such door frame and holding such strike plate in place, drawing an outline around such strike plate, removing such strike plate from such door frame and chiseling a recess into such door frame within such outline such that such strike plate may be fitted into such recess flush with such door frame, providing such first, second, and third screw members and screwing such first, second, and third screw members into such second, third, and fourth apertures of such strike plate respectively and into such door frame thereby securing such strike plate within such recess and to such door frame, removing a plurality of predetermined screws from a plurality of apertures disposed through a plurality of predetermined hinge plates, such hinge plates being secured to such door frame and hingedly securing such door to such door frame, providing a predetermined number of elongated screws having a predetermined length, such predetermined number being equal to the number of such screws removed from such hinge plates, and screwing such elongated screws into such predetermined apertures.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A strike plate comprising:
a. a substantially flat member, manufactured from a predetermined material and having a predetermined size and a predetermined shape, said substantially flat member including a first aperture disposed there through for receiving a bolt portion of a deadbolt attached to a door; and
b. a securing means engageable with said substantially flat member and a door frame of such door for securing said substantially flat member to such door frame.

2. A strike plate according to claim 1 wherein said first predetermined material is a metal.

3. A strike plate according to claim 2 wherein said metal is at least one of aluminum and steel.

4. A strike plate according to claim 3 wherein said metal is steel.

5. A strike plate according to claim 1 wherein said securing means is a screw type securing means and said substantially flat member further includes at least one second aperture disposed there through for receiving at least one screw member there through.

6. A strike plate according to claim 5 wherein said strike plate further includes a second aperture for receiving a first screw member having a first predetermined length, said second aperture disposed through said substantially flat member above said first aperture, a third aperture for receiving a second screw member having a second predetermined length, said third aperture disposed through said substantially flat member below said first aperture, and a fourth aperture for receiving a third screw member having a third predetermined length disposed through said substantially flat member at a predetermined location.

7. A strike plate according to claim 6 wherein said predetermined shape is substantially L-shaped.

8. A strike plate according to claim 7 wherein said first and second predetermined lengths are substantially identical and said third predetermined length is longer than said first and second predetermined lengths.

9. A strike plate according to claim 8 wherein said L-shaped substantially flat member includes a first elongated arm for vertical placement on such door frame and a second shorter arm extending horizontally from a first predetermined end of said first elongated arm and wherein said first aperture is disposed through a substantially central portion of said first elongated arm and said fourth aperture is disposed through a substantially central portion of such second shorter arm.

10. A strike plate according to claim 1 wherein said strike plate is between about 3.0 inches and 4.0 inches in length.

11. A strike plate kit for use with a door hingedly mounted to a door frame, such door including a deadbolt type lock, said strike plate kit comprising:
a. a strike plate including;
i. a substantially flat member, manufactured from a predetermined material and having a predetermined size, said substantially flat member being L-shaped, said L-shaped substantially flat member including a first elongated arm and a second shorter arm, said substantially flat member further including a first aperture disposed through said first elongated arm for receiving a bolt portion of such deadbolt, a second aperture for receiving a first screw member having a first predetermined length, said second aperture disposed through said first elongated arm above said first aperture, a third aperture for receiving a second screw member having a second predetermined length, said third aperture disposed through said first elongated arm below said first aperture, and a fourth aperture disposed through said second shorter arm at a predetermined location for receiving a third screw member having a third predetermined length; and
ii. said first, second, and third screw members for screwing through said second, third, and fourth apertures and into such door frame thereby securing said substantially flat member to such door frame; and
b. a plurality of elongated screws having a predetermined size and a predetermined length for replacing a plurality of predetermined screws from such hinges connecting such door to such door frame.

12. A strike plate kit according to claim 11 wherein said third screw member is elongated.

13. A method of securing a door hingedly connected to a door frame and including a deadbolt type lock against forced entry, said method comprising the steps of:
a. providing a strike plate including a substantially flat member, manufactured from a predetermined material and having a predetermined size, said substantially flat member being L-shaped and including a first elongated arm and a second shorter arm, said substantially flat member further including;
i. a first aperture disposed through said first elongated arm for receiving a bolt portion of such deadbolt;
ii. a second aperture for receiving a first screw member having a first predetermined length, said second aperture disposed through said first elongated arm above said first aperture;
iii. a third aperture for receiving a second screw member having a second predetermined length, said third aperture disposed through said first elongated arm below said first aperture;
iv. a fourth aperture for receiving a third screw member having a third predetermined length disposed through said second shorter arm at a predetermined location;
b. aligning said strike plate at a predetermined location on such door frame and holding said strike plate in place;
c. drawing an outline around said strike plate;
d. removing said strike plate from such predetermined location and chiseling a recess into such door frame within such outline such that said strike plate may be fitted into said recess flush with said door frame.
e. providing said first, second, and third screw members and screwing said first, second, and third screw members into said second, third, and fourth apertures of said strike plate respectively and into such door frame thereby securing said strike plate within such recess to such door frame;
f. removing a plurality of predetermined screws from a plurality of apertures disposed through a plurality of predetermined hinge plates, said hinge plates being secured to said door frame and hingedly securing said door to said door frame;
g. providing a predetermined number of elongated screws having a predetermined length, said predetermined number being equal to a number of said predetermined screws removed from said hinge plates; and
h. screwing said elongated screws into said predetermined apertures of said hinge plates.
